(19) United States
(12) Patent Application Publication
(10) Pub. No.: US 2018/0318995 A1
(43) Pub. Date: Nov. 8, 2018

(54) ELECTRIC STAPLER

(71) Applicant: APEX MFG. CO., LTD., Taichung City (TW)

(72) Inventors: Jing- Li WANG, Taichung City (TW); Py-Yi CHANG, Taichung City (TW)

(21) Appl. No.: 15/588,121

(22) Filed: May 5, 2017

(51) Int. Cl. B25C 5/02; B25C 5/15; G01D 5/32

(52) U.S. Cl. CPC B25C 5/0228; G01D 5/32; B25C 5/15

(57) ABSTRACT

The electric stapler includes a main body, a striking device, a pivot element, and a switch. The main body encloses a receiving space and has a front opening. The striking device is arranged in the receiving space and includes a movable striking mechanism. An end of the pivot element is pivotally connected to the striking mechanism, and an other end of the pivot element has a pressing portion. The switch is arranged in the receiving space of the main body and is connected to the striking device. The striking mechanism is driven to move to a striking position to strike a nail out when the switch is triggered. The switch is triggered when the pressing portion is pushed toward the switch by a papersheet.

### BACKGROUND OF THE INVENTION

### Field of the Invention

The present invention relates to an electric stapler.

### Description of the Prior Art

A conventional electric stapler is shown in patent TW 577378. A button or triggering piece is arranged inside the opening of the stapler. When a papersheet is inserted into the opening, the papersheet pushes the button to trigger a switch. Thus, a striking device of the stapler strikes a nail out.

However, the button is under an elastic force by elastic element or others. That is, the papersheet has to push the button strongly to overcome the elastic force, so the front edge of the papersheet may be folded or curled. As a result, the position of the nail may be deviated.

Besides, the button, which corresponds to the front edge of the papersheet, and the striking portion, which corresponds to the position of the nail, are too close to each other. Thus, the button is possible to be damaged when the striking portion strikes the nail out.

### SUMMARY OF THE INVENTION

The main object of the present invention is to provide an electric stapler which is able to sense the papersheet and to strike the nail out automatically.

To achieve the above and other objects, an electric stapler of the present invention includes a main body, a striking device, a pivot element, and a switch.

The main body encloses a receiving space and has a front opening. The striking device is arranged in the receiving space and includes a movable striking mechanism. The striking mechanism is movable between an original position and a striking position. The striking mechanism tends to retain at the original position. The striking mechanism has a striking portion. An end of the pivot element is pivotally connected to the striking mechanism, and an other end of the pivot element has a pressing portion. The pivot element is closer to the front opening of the main body than the striking portion is. The switch is arranged in the receiving space of the main body and is connected to the striking device. The striking mechanism is driven to move to the striking position to make the striking portion strike a nail out when the switch is triggered. The switch is triggered when the pressing portion is pushed toward the switch by a papersheet.

Thereby, when the papersheet is inserted into the front opening and pushes the pivot element, the pivot element pushes the triggering element to trigger the switch so that the striking mechanism moves downward to strike the nail out.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a profile of the present invention;

FIGS. 4 to 6 are illustrations of the present invention when triggering;

FIG. 7 is a stereogram of a pivot element of the present invention;

FIG. 8 is a stereogram of an elastic guiding element of the present invention;

FIG. 9 is an illustration of the present invention;

FIGS. 10 and 11 are illustrations of the present invention when guiding;

FIG. 12 is a partial breakdown drawing of the present invention.

### DETAILED DESCRIPTION OF THE PREFERRED EMBODIMENTS

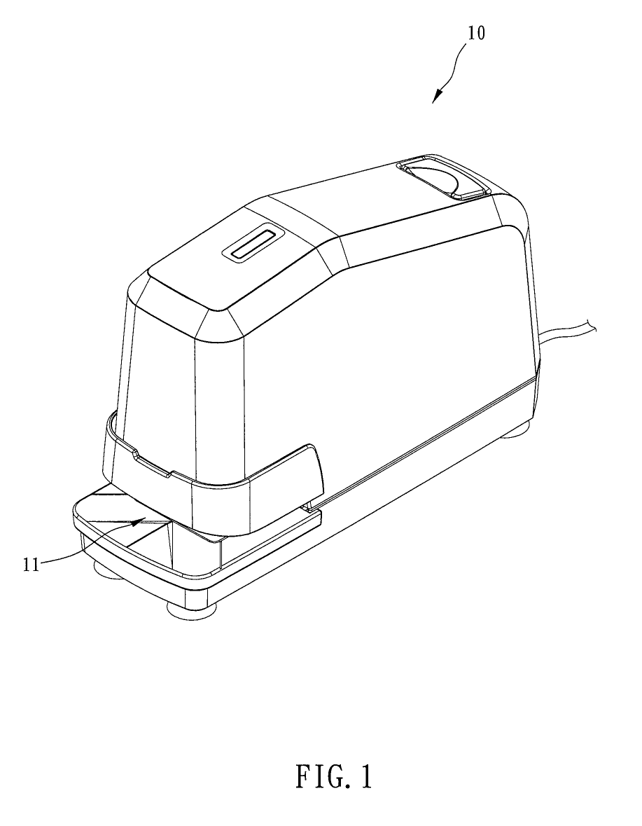

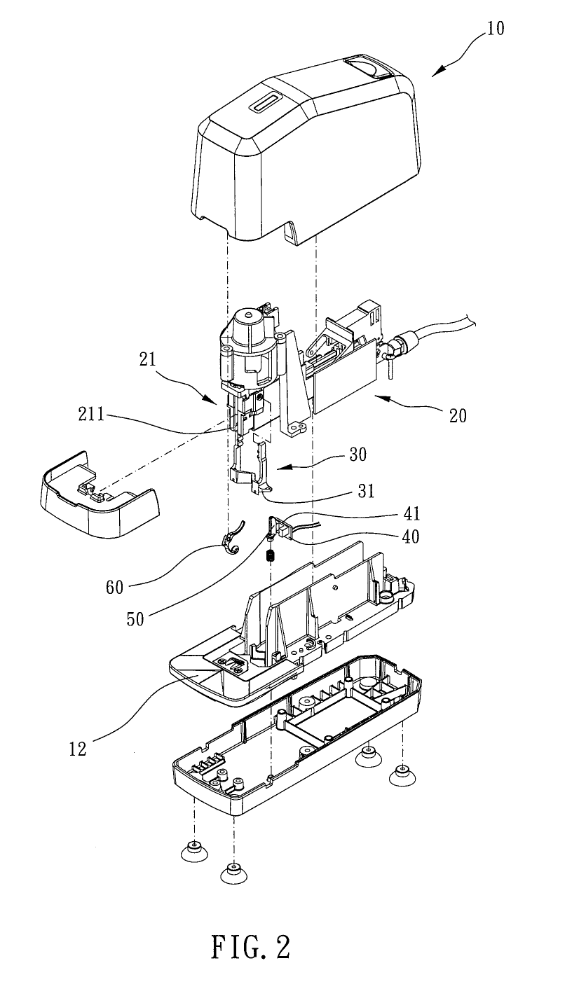

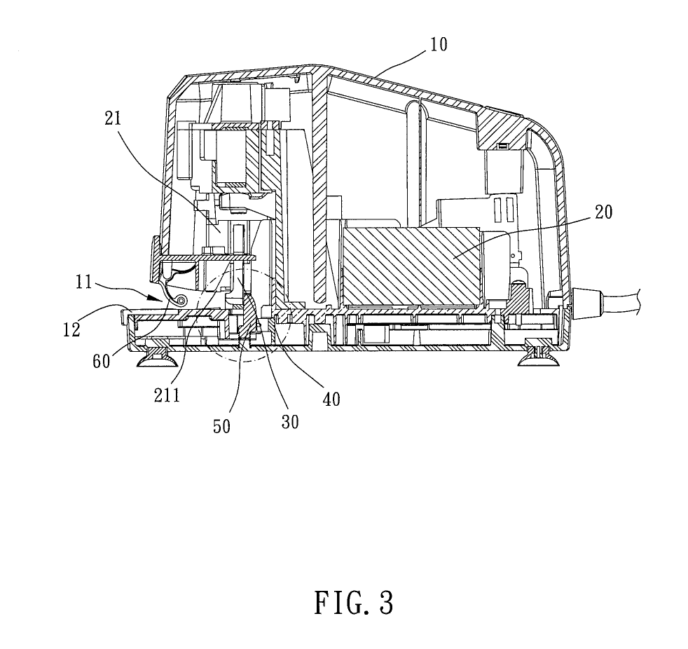

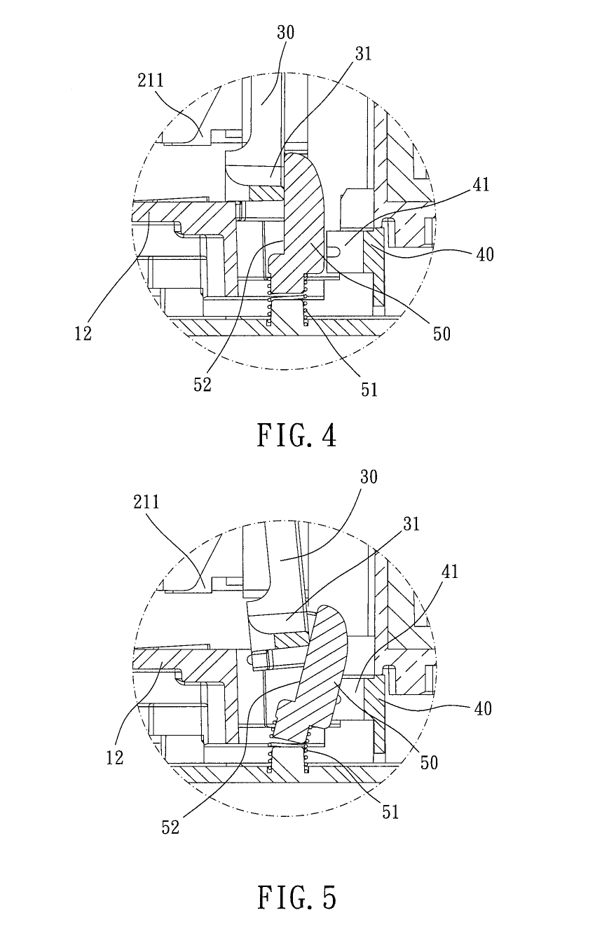

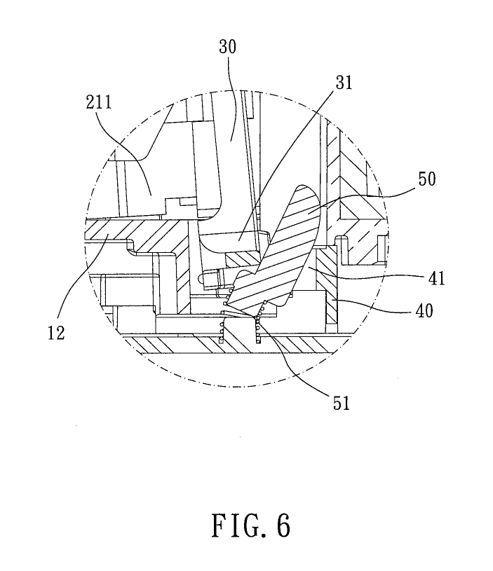

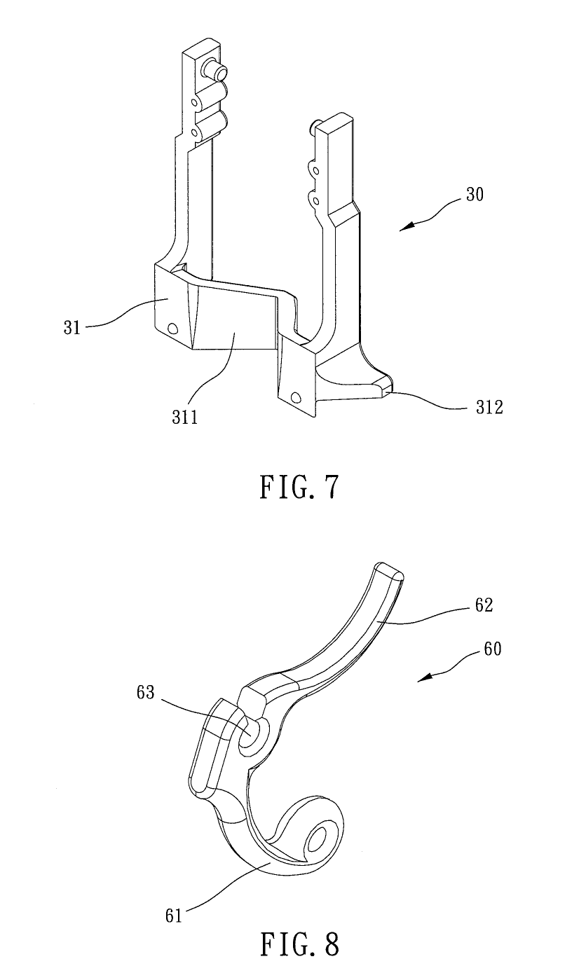

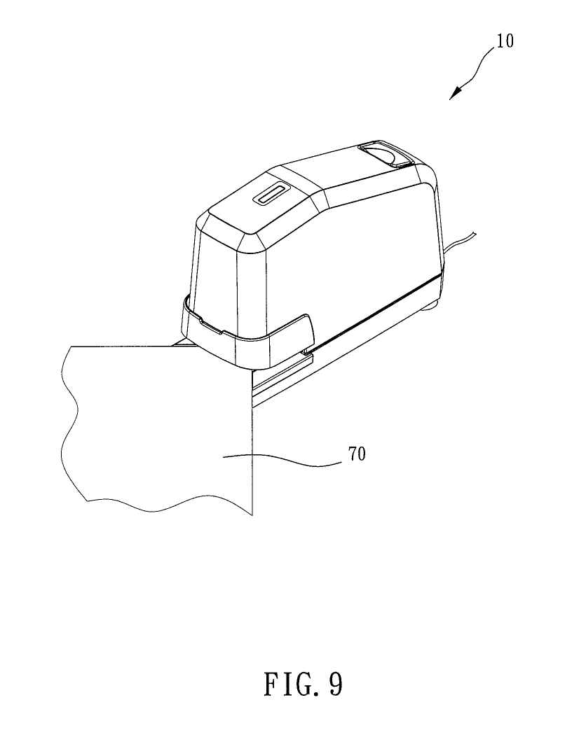

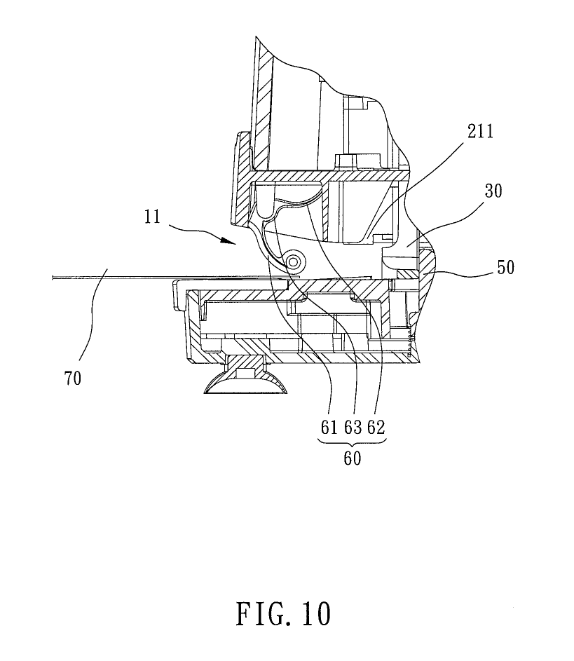

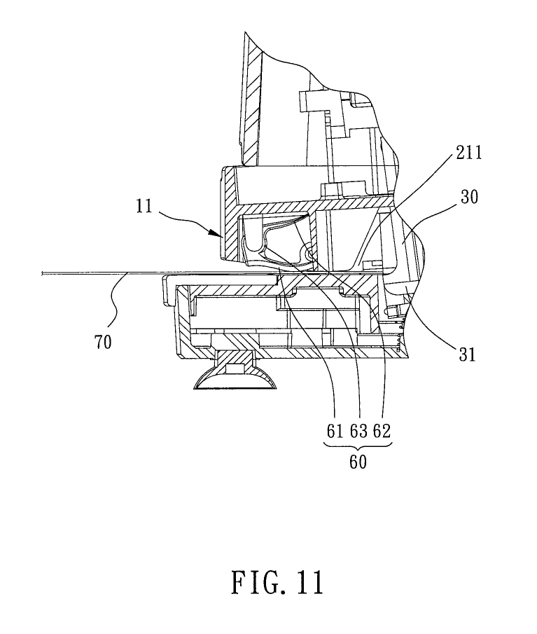

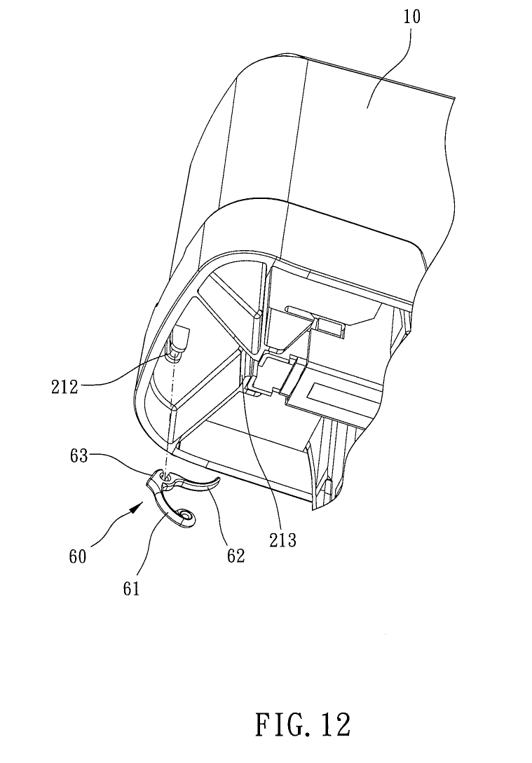

Please refer to FIG. 1 to FIG. 12, the electric stapler of the present invention includes a main body 10, a striking device 20, a pivot element 30, a switch 40, and a triggering element 50.

The main body 10 encloses a receiving space and has a front opening 11. A working platform 12 is provided at the bottom of the front opening 11. The striking device 20 is arranged in the receiving space and includes a movable striking mechanism 21. The striking mechanism 21 is movable between an original position and a striking position. The striking mechanism 21 tends to retain at the original position. The striking mechanism 21 has a striking portion 211. An end of the pivot element 30 is pivotally connected to the striking mechanism, and an other end of the pivot element 30 has a pressing portion 31. The pivot element 30 is closer to the front opening 11 of the main body 10 than the striking portion 211 is. The switch 40 is arranged in the receiving space of the main body 10 and is connected to the striking device 20. The striking mechanism 21 is driven to move to the striking position to make the striking portion 211 strike a nail out when the switch 40 is triggered. The switch 40 is triggered when the pressing portion 31 is pushed toward the switch 40 by a papersheet 70.

More specifically, the pressing portion 31 of the pivot element 30 includes a pressing face 311 and a pushing portion 312. The pressing face 311 is V-shaped for a corner of the papersheet 70 to abut against. The pushing portion 312 is adapted for pushing the triggering element 50. Preferably, the pressing face 311 has a V-shaped corner which is 90 degrees and faces the front opening 11 of the main body 10. As a result, the nail can be clipped on the papersheet at 45 degrees. In addition, the two perpendicular fringes of the papersheet push the pivot element 30 together, so the papersheet is prevented from curling or bent. Besides, the pivot element 30 includes two pivot arms which are located at two sides of the pressing face 311 respectively and are connected to the pressing face 311 respectively. Another end of each pivot arm is pivotally connected to the striking mechanism 21. Thus, the pivot element 30 is substantially swing-shaped to make the position of the pressing face 311 precise.

The triggering element 50 further includes an elastic element 51. The triggering element 50 is connected to a bottom of the main body 10 via the elastic element 51 to have a tendency to retain at the reset position. More specifically, the main body 10 is formed with a protrusion on the bottom thereof, and the elastic element 51 is biased between the protrusion and the triggering element 50 so that the triggering element 50 is able to swing but tends to retain vertical. Besides, the triggering element 50 has a recess 52 on a face thereof facing the pivot element 30. The recess 52 extends vertically to allow the pivot element 30 to move up and down.

In other possible embodiments, the triggering element can be ignored. That is, the triggering element is formed with the pivot element integrally as a single piece. In other words, the triggering element is an extension of the pivot element.

In the present embodiment, the switch 40 is a U-shaped photoelectric switch. The switch 40 has a sensing groove 41. A ray is emitted from a lateral wall of the sensing groove 41 and is sensed by an opposite lateral wall of the sensing groove 41. When the triggering element 50 is located at the triggering position, the triggering element 50 is at least partially received in the sensing groove 41 to block the ray. When the switch 40 doesn't detect the ray, it triggers the striking device 20 to strike the nail out.

In addition, an elastic guiding element 60 is also included. The elastic guiding element 60 is disposed on the front portion of the striking mechanism 21 and includes a guiding portion 61, an elastic means 62, and a pivot portion 63. The pivot portion 63 is pivotally disposed on the front portion of the striking mechanism 21. The guiding portion 61 extends toward the striking portion 211 and is pivotable up and down. The guiding portion 61 tends to pivot downward due to the elastic means 62. For example, the elastic means abuts against an abutting surface of the front portion of the striking mechanism to provide an elasticity to the guiding portion. When the striking mechanism 21 moves toward the striking position, the guiding portion 61 abuts against the papersheet 70 placed on the working platform 12 so that the guiding portion 61 pivots upward to compress the elastic means 62. Thus, the guiding portion 61 pulls the papersheet 70 toward the striking portion 211 to position the papersheet 70 at the desired position.

In use, the papersheet 70 is inserted into the front opening 11 of the main body 10 with a corner thereof to abut against the pressing face 311 of the pivot element 30, and the papersheet 70 further pushes the pivot element 30 to pivot to further push the triggering element 50 to trigger the switch 40. Thereby, the striking mechanism 21 is driven to move down to strike the nail out.

Because of the mechanism of pivot element 30 and the triggering element 50, the papersheet 70 is able to trigger the stapler more easily. Besides, the V-shaped abutting portion 42 ensures the position of the nail accurate. Also, the papersheet may not be folded or curled.

What is claimed is:

1. An electric stapler, including:
a main body, enclosing a receiving space and having a front opening;
a striking device, arranged in the receiving space and including a movable striking mechanism, the striking mechanism being movable between an original position and a striking position, the striking mechanism tending to retain at the original position, the striking mechanism having a striking portion;
a pivot element, an end of the pivot element being pivotally connected to the striking mechanism, an other end of the pivot element having a pressing portion, the pivot element being closer to the front opening of the main body than the striking portion is;
a switch, arranged in the receiving space of the main body and connected to the striking device, the striking mechanism being driven to move to the striking position to make the striking portion strike a nail out when the switch is triggered;
wherein the switch is triggered when the pressing portion is pushed toward the switch by a papersheet.

2. The electric stapler of claim 1, further including a triggering element, the triggering element being movably arranged between the switch and the pressing portion of the pivot element, the triggering element being movable between a reset position and a triggering position and tending to retain at the reset position, the triggering element being pushed to move toward the triggering position when the pressing portion of the pivot element is pushed by a papersheet and the pivot element is moved toward the triggering element, the triggering element triggering the switch when the triggering element is located at the triggering position.

3. The electric stapler of claim 2, wherein the pressing portion of the pivot element includes a pressing face and a pushing portion, the pressing face is V-shaped for a corner of the papersheet to abut against, the pushing portion is adapted for pushing the triggering element.

4. The electric stapler of claim 3, wherein the pivot element includes two pivot arms, the two pivot arms are located at two sides of the pressing face respectively and are connected to the pressing face respectively, another end of each pivot arm is pivotally connected to the striking mechanism.

5. The electric stapler of claim 3, wherein the pressing face has a V-shaped corner which is 90 degrees and faces the front opening of the main body.

6. The electric stapler of claim 2, wherein the triggering element includes an elastic element, the triggering element is connected to a bottom of the main body via the elastic element to have a tendency to retain at the reset position.

7. The electric stapler of claim 6, wherein the triggering element has a recess on a face thereof facing the pivot element, the recess extends along a vertical direction to allow the pivot element to move up and down.

8. The electric stapler of claim 2, wherein the switch is a photoelectric switch and has a sensing groove, a ray is emitted from a lateral wall of the sensing groove and is sensed by an opposite lateral wall of the sensing groove, the triggering element is at least partially received in the sensing groove to block the ray when the triggering element is located at the triggering position.

9. The electric stapler of claim 1, further including an elastic guiding element, the elastic guiding element being located in front of a front portion of the striking mechanism, the elastic guiding element includes a guiding portion, an elastic means, and a driving portion, the driving portion being pivotally disposed on the front portion of the striking mechanism, the guiding portion extending toward the striking portion and being pivotable up and down, the guiding portion tending to pivot downward due to the elastic means, the main body having a working platform near the front opening, the guiding portion abutting against the papersheet placed on the working platform when the striking mechanism is moved toward the striking position so that the guiding portion pivot upward to compress the elastic means and that the guiding portion further pulls the papersheet toward the striking portion.
